(19) United States
(12) Patent Application Publication
(10) Pub. No.: US 2010/0178814 A1
(43) Pub. Date: Jul. 15, 2010

(54) ELECTRICAL TERMINAL

(76) Inventor: DAVID BRYER, DEARBORN, MI (US)

Correspondence Address: HOWARD & HOWARD ATTORNEYS PLLC, 450 West Fourth Street, Royal Oak, MI, 48067, US

(21) Appl. No.: 12/351,972

(22) Filed: Jan. 12, 2009

(51) Int. Cl. H01R 13/115

(52) U.S. Cl. 439/842

(57) ABSTRACT

An electrical terminal having a body and a pair of beams extending away from the body, each of the beams having a first end attached to the body and a second end distal to the body. The beams form a slot therebetween, and are sufficiently flexible in order to enable the slot to open in response to the insertion of an electrical device therein. Each of the beams has an inboard side proximate to the slot and an outboard side opposite the inboard side. The inboard sides of the beams are parabolic in shape. As a result of this parabolic shape, the beams distribute stress more evenly along the inboard and outboard sides of the beams. Consequently, concentration of stress on the beams proximate to the body is reduced significantly, and, therefore, the risk that the terminal will exceed its yield strength and have permanent deformation of the beams is reduced.

### FIELD OF THE INVENTION

The present invention relates to electrical terminals and, more particularly, to electrical fork terminals.

### BACKGROUND OF THE INVENTION

Electrical fork terminals are used in connection with electrical distribution boxes. Electrical fork terminals are typically manufactured by stamping a conductive material, such as a copper alloy, and would ideally have the highest temper (i.e., the most internal stresses) available. As a device blade, such as a fuse blade, relay blade, etc., is inserted into a slot of an electrical fork terminal, the fork beams of the terminal are spread apart, effectively applying a known displacement to the free ends of the fork beams. The internal stresses initially present within the terminal increase its strength and allow the terminal's fork beams to counteract this displacement by pushing back with a high normal force. Preferably, the internal stresses must be below the terminal's yield point, but still allow for the additional stress that occurs during the insertion of the device blade within the terminal. If, however, the internal stresses exceed the terminal's material yield point, permanent deformation in the geometry of the terminal occurs (e.g., the fork beams would bend and the slot would increase), thereby reducing the overall performance of the terminal and its ability to carry electrical current either to or from the inserted device blade.

Presently known electrical fork terminals do not evenly distribute stress along their fork beams. Rather, stress is concentrated near the root of the fork terminal along the inside and outside edges. These localized areas are prone to permanent damage from the stress exceeding the terminal's material yield point. What is needed, therefore, is an electrical fork terminal having a geometry that evenly distributes internal stresses and reduces the maximum stress within the terminal so as to avoid permanent deformation in the geometry of the terminal.

### SUMMARY OF THE INVENTION

The problems and disadvantages associated with the prior art are overcome by the present invention, which includes an electrical terminal for providing an electrical connection to an electrical device. The terminal has a body and a pair of beams extending away from the body, each of the beams having a first end attached to the body and a second end distal to the body. The beams form a slot therebetween, and are sufficiently flexible in order to enable the slot to open in response to the insertion of an electrical device into the slot. Each of the beams has an inboard side proximate to the slot and an outboard side opposite the inboard side. The inboard sides of the beams are parabolic in shape. As a result of this geometry, the beams distribute stress more evenly along the inboard and outboard sides of the beams. Consequently, concentration of stress on the beams proximate to the body is reduced significantly, and, therefore, the risk that the terminal will exceed its material yield strength and have permanent deformation of the beams is reduced.

Further features and advantages of the invention will appear more clearly on a reading of the detailed description of the exemplary embodiments of the invention, which are given below by way of example only with reference to the accompanying drawings.

### BRIEF DESCRIPTION OF THE DRAWINGS

For a better understanding of the present invention, reference is made to the following detailed description of the exemplary embodiment considered in conjunction with the accompanying drawings, in which:

FIG. 1 is a front elevational view of an electrical terminal constructed in accordance with an exemplary embodiment of the present invention;

FIG. 2 is a front elevational view of the electrical terminal shown in FIG. 1 as it is being connected to a device blade; and

FIG. 3 is a front elevational view of stress distribution analysis of the electrical terminal shown in FIG. 2.

### DETAILED DESCRIPTION OF THE DRAWINGS

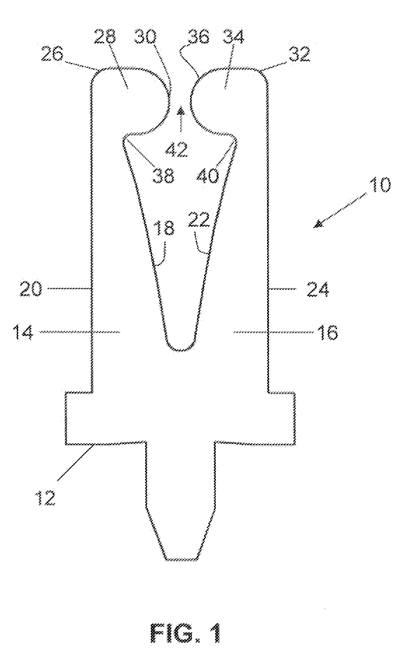

Referring to FIG. 1, an electrical terminal 10 includes a body 12 and a pair of cantilevered fork beams 14, 16 that extend from the body 12 in a longitudinal direction. The beam 14 has an inboard side 18 and an outboard side 20 opposite the inboard side 18. Similarly, the beam 16 has an inboard side 22 and an outboard side 24 opposite the inboard side 22. In an embodiment, the outboard sides 20, 24 of the beams 14, 16 are parallel to one another, but they need not be. Each of the inboard sides 18, 22 of the beams 14, 16 are parabolic in shape. In another embodiment, the outboard sides 20, 24 of the beams 14, 16 are parabolic in shape, while the inboard sides 18, 22 of the beams are straight (not shown in the Figures). The term “parabolic” means having the form or outline of a parabola.

Still referring to FIG. 1, a free end 26 of the beam 14 includes a first contact 28 having a contact area 30, while a free end 32 of the beam 16 includes a second contact 34 having a contact area 36. The beams 14, 16 converge at their respective free ends 26, 32. It is noted that the free ends 26, 32 of the beams 14, 16 are resiliently biased, but they can be forced apart in a manner that will be described hereinafter. The inboard side 18 of the beam 14 terminates at the first contact 28 in the form of a semi-circular-shaped notch 38, whose function shall be described hereinafter. Similarly, the inboard side 22 of the beam. 16 terminates at the second contact 34 in the form of a semi-circular-shaped notch 40, whose function shall be described hereinafter. The contact areas 30, 36 of the contacts 28, 34 form a slot 42 therebetween, whose function shall be described hereinafter.

It is noteworthy that the body 12 can consist of many different shapes and sizes, depending upon the specific application of the terminal 10. While the notches 38, 40 are semi-circular in shape, it should be noted that the can consist of other shapes and sizes. Overall, the terminal 10 has a general “fork” shape, but it can consist of different shapes and sizes as contemplated by the teachings herein. In addition, the terminal 10 is preferably manufactured from copper alloy. However, the terminal 10 may be made from other electrically conductive materials, such as, for example, aluminum.

Specifically, the terminal 10 has been adapted for receiving a device blade (such as, for example, fuse blades, relay blades, etc.) used in connection with motor vehicle electrical distribution boxes. However, the terminal 10 can be utilized in various types of electrical applications, such as telecommunications applications.

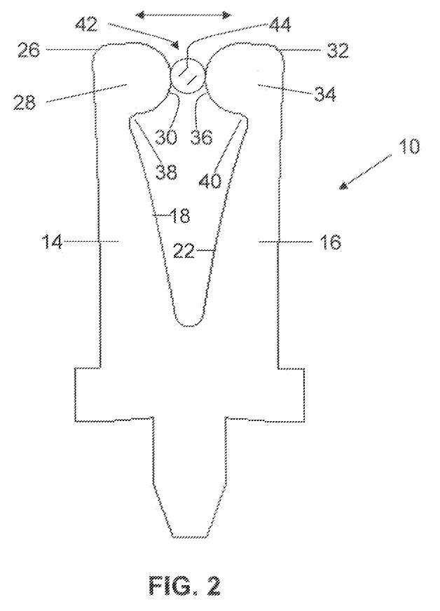

Referring to FIG. 2, a device blade 44 is inserted into the slot 42 and makes initial contact with the terminal 10. The device blade 44 is generally shown and can be any suitable electrical component such as, for example, a fuse blade, a relay blade, or the like. Lateral forces are exerted by the device blade 44 at the contact areas 30, 36 and, in turn, against the beams 14, 16. These lateral forces cause the beam 14 to flex at the notch 38 and the beam 16 to flex at the notch 40, thereby causing the beams 14, 16 to spread apart from one another. As the device blade 44 is further inserted into the slot 42 and between the contacts 28, 34, the beams 14, 16 are spread apart and effectively the free ends 26, 32 are displaced. As the beams 14, 16 counteract this displacement, internal stresses within the terminal 10 arise.

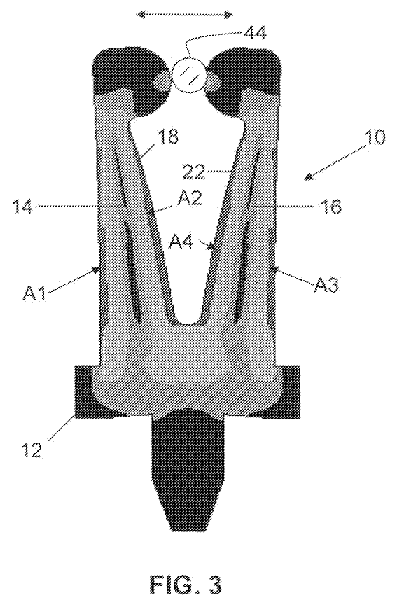

The parabolic-shaped inboard sides 18, 22 of the beams 14, 16 evenly distribute the internal stresses that arise within the terminal 10. More particularly, as shown in FIG. 3, the parabolic-shaped inboard sides 18, 22 of the beams 14, 16 distribute stress more evenly along the inboard and outboard sides 18, 22, as shown by areas A1, A2 and A3, A4, respectively. Consequently, concentration of stress on the beams 14, 16 proximate to the body 12 is reduced significantly, and, therefore, there is a reduction of a risk that the terminal 10 will exceed its material yield strength and have permanent deformation of the beams 14, 16.

It should be understood that the embodiments described herein are merely exemplary and that a person skilled in the art may make many variations and modifications without departing from the spirit and scope of the invention. Accordingly, all such variations and modifications are intended to be included within the scope of the invention as defined in the appended claims.

What is claimed is:

1. An electrical terminal, comprising a body; a pair of beams extending away from the body, each of the beams having a first end attached to the body and a second end distal to the body, each of the beams forming a slot therebetween, each of the beams being sufficiently flexible in order to enable the slot to open in response to the insertion of an electrical device into the slot, wherein the second ends of the beams are movable between a first position, in which the second ends are proximate to each other, and a second position, in which the second ends are spaced apart from each other, wherein the second ends of the beams move from the first position to the second position in response to the insertion of the electrical device in the slot, each of the beams having an inboard side proximate to the slot and an outboard side opposite the inboard side, at least one of the inboard sides of one of the beams is parabolic in shape and extends from the first end of the one of the beams towards the second end of the one of the beams.

2. The electrical terminal as claimed in claim 1, wherein each of the inboard sides of the beams is parabolic in shape, the inboard side of one of the beams extends from the first end of the one of the beams towards the second end of the one of the beams, and the inboard side of the other of the beams extends from the first end of the other of the beams towards the second end of the other of the beams.

3. The electrical terminal as claimed in claim 2, wherein the second end of one of the beams includes a first contact and the second end of the other of the beams includes a second contact, the slot being positioned between the first and second contacts.

4. The electrical terminal as claimed in claim 3, wherein the inboard side of the one of the beams extends from the first end of the one of the beams to the first contact, and the inboard side of the other of the beams extends from the first end of the other of the beams to the second contact.

5. The electrical terminal as claimed in claim 4, wherein the first contact includes a first contact area and the second contact includes a second contact area, wherein the first and second contact areas engage the electrical device and provide an electrical connection between the electrical device and the first and second contacts.

6. The electrical terminal as claimed in claim 5, wherein one of the beams has a first notch formed in the inboard side thereof, and the other of the beams has a second notch formed in the inboard side thereof, wherein the inboard side of the one of the beams extends from the first end of the one of the beams and terminates at the first notch, and the inboard side of the other of the beams extends from the first end of the other of the beams and terminates at the second notch.

7. The electrical terminal as claimed in claim 1, wherein the second ends of the beams are resiliently biased toward the first position.

8. The electrical terminal as claimed in claim 1, wherein the terminal is made from copper.

9. The electrical terminal as claimed in claim 1, wherein the electrical device includes a fuse.

10. The electrical terminal as claimed in claim 1, wherein the electrical device includes a relay.

11. In combination, an electrical device; and an electrical terminal connected to the electrical device, the electrical terminal including a body; a pair of beams extending away from the body in a first direction, each of the beams having a first end attached to the body and a second end distal to the body, each of the beams forming a slot therebetween, each of the beams being sufficiently flexible in order to enable the slot to open in response to the insertion of an electrical device into the slot, wherein the second ends of the beams are movable between a first position, in which the second ends are proximate to each other, and a second position, in which the second ends are spaced apart from each other, wherein the second ends of the beams move from the first position to the second position in response to insertion of the electrical device in the slot, wherein each of the beams has an inboard side proximate to the slot and an outboard side opposite the inboard side, at least one of the inboard sides of one of the beams is parabolic in shape and extends from the first end of the one of the beams towards the second end of the one of the beams.

12. The combination as claimed in claim 11, wherein each of the inboard sides of the beams is parabolic in shape, the inboard side of one of the beams extends from the first end of the one of the beams towards the second end of the one of the beams, and the inboard side of the other of the beams extends from the first end of the other of the beams towards the second end of the other of the beams.

13. The combination as claimed in claim 12, wherein the second end of one of the beams includes a first contact and the second end of the other of the beams includes a second contact, the slot being positioned between the first and second contacts.

14. The combination as claimed in claim 13, wherein the inboard side of the one of the beams extends from the first end of the one of the beams to the first contact, and the inboard side of the other of the beams extends from the first end of the other of the beams to the second contact.

15. The combination as claimed in claim 14, wherein the first contact includes a first contact area and the second contact includes a second contact area, wherein the first and second contact areas engage the electrical device and provide an electrical connection between the electrical device and the first and second contacts.

16. The combination as claimed in claim 15, wherein one of the beams has a first notch formed in the inboard side thereof, and the other of the beams has a second notch formed in the inboard side thereof, wherein the inboard side of the one of the beams extends from the first end of the one of the beams and terminates at the first notch, and the inboard side of the other of the beams extends from the first end of the other of the beams and terminates at the second notch.

17. The combination as claimed in claim 11, wherein the second ends of the beams are resiliently biased toward the first position.

18. The combination as claimed in claim 11, wherein the terminal is made from copper.

19. The combination as claimed in claim 11, wherein the electrical device includes a fuse.

20. The combination as claimed in claim 11, wherein the electrical device includes a relay.
